(19) United States
(12) Patent Application Publication
(10) Pub. No.: US 2015/0291721 A1
(43) Pub. Date: Oct. 15, 2015

(54) CROSSLINKABLE POLYKETAL ESTERS, METHODS OF MANUFACTURE AND USES THEREOF

(71) Applicant: SEGETIS, INC., Golden Valley, MN (US)

(72) Inventors: Brian D. Mullen, Delano, MN (US); Erich Joseph Molitor, Midland, MN (US)

(73) Assignee: SEGETIS, INC., Golden Valley, MN (US)

(21) Appl. No.: 14/441,932

(22) PCT Filed: Nov. 12, 2013
(86) PCT No.: PCT/US2013/069626

§ 371 Date: May 11, 2015

Related U.S. Application Data
(60) Provisional application No. 61/725,284, filed on Nov. 12, 2012.

(51) Int. Cl. C08G 16/00; C08K 7/14

(52) U.S. Cl. CPC C08G 16/00; C08K 7/14

(57) ABSTRACT

Disclosed herein is a crosslinkable polyketal ester obtained by the esterification of a hydrocarbon polyol by at least 2 equivalents of a ketocarboxylic acid to produce an intermediate polyketocarboxylic ester. The intermediate polyketocarboxylic ester is then ketalized to produce the crosslinkable polyketal ester, which can then be used in compositions or crosslinked.

### CROSS REFERENCE TO RELATED APPLICATION

This application claims the benefit of U.S. Patent Application No. 61/725,284, filed on Nov. 12, 2012, which is incorporated by reference herein in its entirety.

### BACKGROUND

This disclosure relates to crosslinkable polyketal esters, and in particular to crosslinkable polyketal ester adducts, their method of manufacture, and uses thereof.

Many known monomers and polymers are currently synthesized from non-renewable petroleum-derived or natural gas-derived feedstock compounds that can be expensive. High raw material costs and uncertainty of future supplies requires the discovery and development of useful monomers and polymers that can be made from inexpensive renewable biomass-derived feedstocks and by simple chemical methods. Using renewable resources as feedstocks for chemical processes will reduce the demand on non-renewable fossil fuels currently used in the chemical industry and reduce the overall production of carbon dioxide, the most notable greenhouse gas.

There accordingly remains a need in the art for biosourced monomers and polymers. It is also desirable that such materials be synthesized economically in large volumes, via simple chemical methodology that is easily implemented using known industrial methodologies and processes. A still further advantage would be manufacture of the chemical additives in higher purity.

### SUMMARY

Disclosed herein is a method for the manufacture of a crosslinkable polyketal ester comprising units (I)

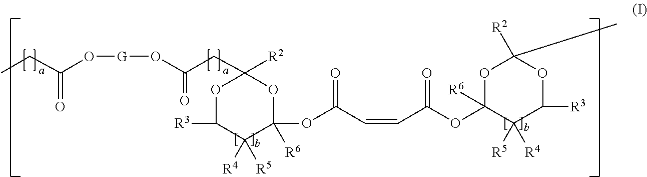

and optionally units (VII)

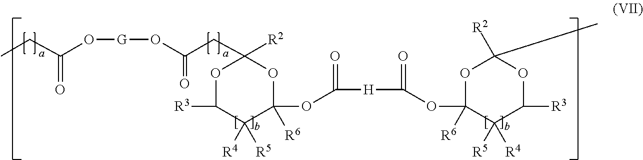

wherein

H is a divalent linking group having more than 2 carbon atoms,

G is a hydrocarbon group,

R² is C₁-C₆ alkyl,

R³ is hydrogen or C₁-C₆ alkyl,

R⁴ and R⁵ are each independently hydrogen or C₁-C₆ alkyl,

R⁶ is hydrogen or C₁-C₆ alkyl, or R³ and R⁶ together with their directly attached carbons form a fused cycloaliphatic or aromatic ring having a total of 5-6 carbon atoms or 4-5 carbon atoms and 1-2 oxygen atoms,

a=0-3, and

b=0 or 1, and optionally units (VII) the method comprising:

(a) esterifying a hydrocarbon polyol (II)

HO-G-OH (II)

with at least 2 equivalents of a ketocarboxy(III) and an esterification catalyst,

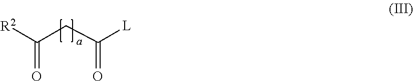

wherein each ketocarboxy (III) is the same or different, and wherein L is hydroxy, halide, or OR¹¹ wherein R¹¹ is a C₁-C₄ alkyl, to form a polyketocarboxylic ester (IV)

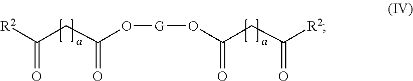

and

(b) ketalizing polyketocarboxylic ester (IV) with a molar excess of polyol (V) or bisketal (VIII) and optionally polyol (VI)

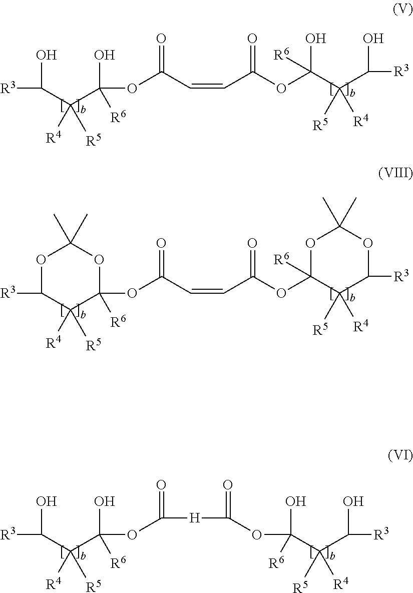

in the presence of a ketalization catalyst to provide the crosslinkable polyketal ester comprising units (I) and optionally units (VII).

Further disclosed is a method for crosslinking the crosslinkable polyketal ester comprising units (I) and optionally units (VII), comprising crosslinking the crosslinkable polyketal ester in the presence of an initiator and a crosslinking agent.

Further disclosed is a composition comprising the crosslinkable polyketal ester comprising units (I) and optionally units (VII).

Further disclosed is a composition comprising the crosslinked polyketal ester comprising units (I) and optionally units (VII).

Also disclosed is a polymer formulation comprising the crosslinkable polyketal ester or crosslinked product thereof.

Articles comprising the crosslinkable polyketal ester, the crosslinked polyketal ester, or the polymer formulations are also disclosed.

### DETAILED DESCRIPTION

The inventors hereof have found that crosslinkable polyketal esters (I) can be efficiently produced by a process wherein a hydrocarbon polyol is esterified with 1.5 or more equivalents of a ketocarboxylic acid to produce an intermediate polyketocarboxylic ester (IV). The polyketocarboxylic ester is then ketalized with a tetrol or higher polyol or a bisketal containing ethylenic unsaturation to produce the crosslinkable polyketal ester comprising units (I).

In a particularly advantageous aspect, both the hydrocarbon polyol and the ketocarboxylic acid can be biosourced.

In an embodiment, the intermediate polyketocarboxylic ester (IV) is isolated, for example by crystallization or distillation, to produce a highly purified crosslinkable polyketal ester in higher purity and/or at higher yields than those produced if the polyketocarboxylic ester was not isolated. Alternatively, in another advantageous aspect, the process can proceed continuously without isolation of the intermediate polyketocarboxylic ester. In still another advantageous feature, the crosslinkable polyketal esters (I) can be obtained in high purity.

The method for the manufacture of crosslinkable polyketal ester comprising units (I) comprises esterifying hydrocarbon diol (II)

HO-G-OH (II)

wherein G is a hydrocarbon group. In an embodiment, G is a C₂-C₃₂ hydrocarbon containing 1 or more straight chain, branched or cyclic groups that can be saturated, unsaturated, aromatic, or substituted with up to 12 ether oxygens; more specifically, G is a C₂-C₁₂ alkylene, C₅-C₈ cycloalkylene, or C₆-C₁₂ arylene, optionally substituted with up to 5 ether oxygens; or G is a C₂-C₈ alkylene, C₂-C₈ alkylene, C₅-C₈ cycloalkylene, or C₆-C₁₂ arylene, or C4-16 alkyleneoxy group of the formula —(R¹²O)_{q}R¹²— wherein each R¹² is independently ethylene, 1,3-propylene, or 1,2-propylene and q=1-7; or a C₂₋C₆ alkylene; or butylene.

Hydrocarbon polyol II is esterified with at least 1.5 equivalents of ketocarboxy (III),

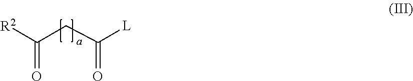

wherein each ketocarboxy (III) is the same or different. R² in formula (III) is C₁-C₆ alkyl, specifically a C₁-C₄ alkyl, more specifically a C₁-C₂ alkyl, even more specifically methyl.

Further in formula (III), a=0-3, more specifically 1-2, still more specifically 2. When a is 0, a single bond connects the two carbonyl groups.

Also in formula (III), L is a hydroxy, halide, OR¹¹, or —OC(═O)R¹¹ wherein R¹¹ is a C₁-C₃ alkyl. In a specific embodiment L is hydroxy.

Esterification occurs in the presence of no added catalyst (the ketocarboxy (III) can function as a catalyst), an acid esterification catalyst, or a base if L is a halide as described in further detail below. Esterification produces a polyketocarboxylic ester (IV)

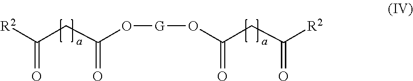

wherein R² and a are as in the ketocarboxy (III). As described below, this product can be used as synthesized or further purified.

Esterification is followed by ketalizing the polyketocarboxylic ester (IV) with an equivalent amount of a polyol (V) or bisketal (VIII)

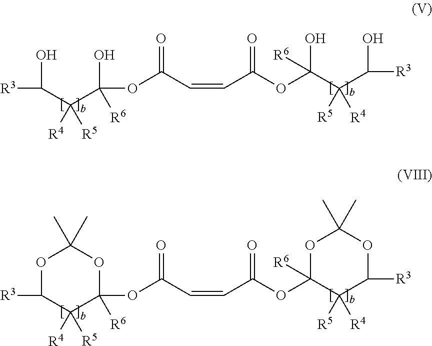

wherein a combination of different polyols (V) or a combination of different bisketals (VIII) can be used. In an embodiment, the same polyol (V) or the same bisketal (VIII) is used.

In formulas (V) and (VIII), each R³ is independently hydrogen or C₁-C₆ alkyl, specifically hydrogen or C₁-C₃ alkyl, more specifically hydrogen.

Each R⁴ and R⁵ in formulas (V) and (VIII) are each independently hydrogen or C₁-C₆ alkyl, specifically hydrogen or C₁-C₃ alkyl.

Each R⁶ in formulas (V) and (VIII) is independently hydrogen or C₁-C₆ alkyl, specifically hydrogen or C₁-C₃ alkyl. Further R³ and R⁶ together with their directly attached carbons can form a fused or bridged cycloaliphatic or aromatic ring having a total of 5-6 carbon atoms or 4-5 carbon atoms and 1-2 oxygen atoms, specifically a fused cycloaliphatic or aromatic ring having a total of 5-6 carbon atoms.

Each b in formulas (V) and (VIII) is 0 or 1. When b is 0, the carbon bearing R³ is directly linked to the carbon bearing R⁶.

In addition to the polyol (V) or the bisketal (VIII), an additional polyol (VI) can be present during ketalization, in order to modify the properties of crosslinkable polyketal ester comprising units (I). Additional polyol (VI) has the formula

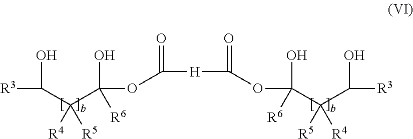

wherein of R³, R⁴, R⁵, R⁶, and b are as defined in formula (V) and H is a divalent linking group having more than 2 carbon atoms. H can be polymeric, comprising 2-500, specifically 5-100, more specifically 10-50 or 2-20 ester, carbonate, or alkylene ether groups. H can also be a C2-32 alkylene, C4-8 cycloalkylene, C6-12 arylene, or C2-32-(R¹²O)_{q}R¹²— wherein each R¹² is methylene, ethylene, 1,3-propylene, or 1,2-propylene and q=1-31. H can be C2-16 alkylene, C6-12 arylene, or C2-16-(R¹²O)_{q}R¹²— wherein R¹² is ethylene or 1,3-propylene, and q=1-15. H can also be C2-8 alkylene, C6-12 arylene, or C4-16-(R¹²O)_{q}R¹²— wherein each R¹² is independently ethylene, 1,3-propylene, or 1,2-propylene, and q=1-7. H more specifically be a C2-8 alkylene or C4-9-(R¹²O)_{q}R¹²— wherein each R¹² is independently ethylene, 1,3-propylene, or 1,2-propylene, and q=1-2. In another embodiment, H is a C2-6 alkylene or —(CH₂CH₂OCH₂CH₂)—. H can also be C2-6 alkylene or C4-12-(R¹²O)_{q}R¹²— wherein R¹² is ethylene or 1,3-propylene and q=1-5; or H can be a C2-6 alkylene or C4-10-(R¹²O)_{q}R¹²— wherein R¹² is ethylene and q=1-4. In another embodiment, H is a C2-6 alkylene or —(CH₂CH₂OCH₂CH₂)—.

In a specific embodiment, H is a C6-12 aromatic compound, in particular a C6 aryl wherein each carboxy group can be in the 1,2, 1,3, or 1,4 positions on the aromatic ring.

In another specific embodiment, H is a straight or branched chain saturated alkylene having from 2-32, or 2-16, or 2-8, or 2-6 carbon atoms. H can alternatively be a cyclic saturated alkylene having from 5-7, or 6 carbon atoms, with the carboxy groups attached in the 1,2, 1,3, or 1,4 positions.

In still another specific embodiment, H is a straight or branched chain alkylene having 4-32 carbon atoms and 2-6 sites of unsaturation, specifically 6-12 carbon atoms and 2 sites of unsaturation.

The specific type and amount of polyol (VI) used in the ketalization will depend on the desired properties of the polymers, for example stiffness, Tg, and the like.

Ketalization of ketocarboxy (III) with polyol (V) or bisketal (VIII) in the presence of a ketalization catalyst provides the crosslinkable polyketal ester comprising units (I)

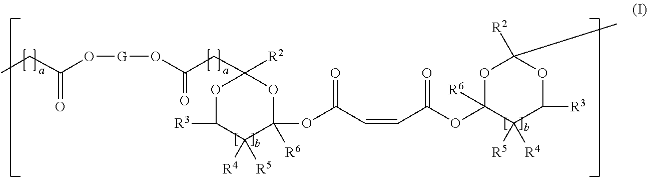

wherein each of G, R², R³, R⁴, R⁵, R⁶, a, and b are as defined in formulas (II), (III), (IV), and (V). The crosslinkable polyketal ester can have from 1 to 500 units (I), specifically 2-400, more specifically 2-300, 2-100, 2-50, 2-35, 2-20, 2-15, 2-10, or 2-5.

In addition to the crosslinkable polyketal ester comprising units (I), various partially ketalized esters can be generated.

When ketalization of ketocarboxy (III) with polyol (V) or bisketal (VIII) is carried out in the presence of additional polyol (VI), the crosslinkable polyketal ester comprising units (I) further comprises units (VII)

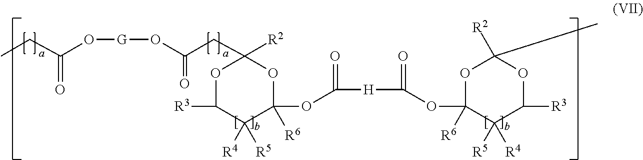

wherein of G, H R², R³, R⁴, R⁵, R⁶, a, and b are as defined in formulas (II), (III), (IV), and (VI). The crosslinkable polyketal ester can have from 1 to 500 units (I), specifically 2-400, more specifically 2-300, 2-100, 2-50, 2-35, 2-20, 2-15, 2-10, or 2-5. The specific type and amount of polyol (VI) used in the ketalization will depend on the desired properties of the polymers, for example stiffness, Tg, and the like, and the ratio of units (I) to units (VII) can be from 99:1 to 1:99, 90:10 to 10:90, 80:20 to 20:80, 70:30 to 30:70, or 760:40 to 40:60. The units (I) and (VII) can be randomly or non-randomly arranged. In a random arrangement, the units (I) and (VII) are distributed randomly in the polymer. In a non-random arrangement, the units (I) and (VII) be arranged in blocks, for example.

In a specific embodiment with reference to each of formulas (II), (III), (IV), (V), (VI), (VII), (VIII), and crosslinkable polyketal ester comprising units (I),

G is a hydrocarbon group having a valence of t,

R² is C₁-C₆ alkyl,

R³ is hydrogen or C₁-C₆ alkyl,

R⁴ and R⁵ are each independently hydrogen or C₁-C₆ alkyl,

R⁶ is hydrogen or C₁-C₆ alkyl, or R³ and R⁶ together with their directly attached carbons form a cycloaliphatic ring having a total of 5-6 carbon atoms or 4-5 carbon atoms and 1-2 oxygen atoms,

a=0-3, and

b=0 or 1.

If units (VI) are present, H can be polymeric, comprising 2-500, specifically 5-100, more specifically 10-50 or 2-20 ester, carbonate, or alkylene ether groups. H can also be a C2-32 alkylene, C4-8 cycloalkylene, C6-12 arylene, or C2-32-(R¹²O)_{q}R¹²— wherein each R¹² is methylene, ethylene, 1,3-propylene, or 1,2-propylene and q=1-31. In this embodiment, each equivalent of ketocarboxy (III) and polyol (V) or bisketal (VIII) (and polyol (VI) if present) can be the same or different. Preferably, each equivalent of ketocarboxy (III) and polyol (V) or bisketal (VIII) (and polyol (VI) if present) is the same.

In another specific embodiment with reference to each of formulas (II), (III), (IV), (V), (VI), (VII), (III), and crosslinkable polyketal ester comprising units (I),

G is a C₂-C₃₂ hydrocarbon containing 1 or more straight chain, branched or cyclic groups that can be saturated, unsaturated, aromatic, or substituted with up to 12 ether oxygens,

each R² is independently C₁-C₃ alkyl,

each R³ is independently hydrogen or C₁-C₃ alkyl,

R⁴ and R⁵ are each independently hydrogen or C₁-C₆ alkyl,

each R⁶ is independently hydrogen or C₁-C₃ alkyl, or R³ and R⁶ together with their directly attached carbons form a cycloaliphatic ring having a total of 5-6 carbon atoms or 4-5 carbon atoms and 1-2 oxygen atoms,

each a independently is 0-3, each b independently is 0 or 1.

If units (VII) are present, H can be a C2-16 alkylene, C4-8 cycloalkylene, or C6-12 arylene. In this embodiment, each equivalent of ketocarboxy (III) and polyol (V) or bisketal (VIII) (and polyol (VI) if present) can be the same or different. Preferably, each equivalent of ketocarboxy (III) and polyol (V) or bisketal (VIII) (and polyol (VI) if present) is the same.

In yet another specific embodiment with reference to each of formulas (II), (III), (IV), (V), (VI), (VII), (VIII), and crosslinkable polyketal ester comprising units (I), where each equivalent of ketocarboxy (III) and polyol (V) or bisketal (VIII) is the same,

G is a C₂-C₈ alkylene, C₂-C₈ alkylene, C₅-C₈ cycloalkylene, or C₆-C₁₂ arylene, or C4-16-(R¹²O)_{q}R¹²— wherein each R¹² is independently ethylene, 1,3-propylene, or 1,2-propylene,

each R² is C₁-C₃ alkyl,

each R³ is hydrogen or C₁-C₃ alkyl,

R⁴ and R⁵ are each independently hydrogen or C₁-C₆ alkyl,

each R⁵ is hydrogen or C₁-C₃ alkyl,

each R⁶ is
hydrogen or C₁-C₃ alkyl, or
R³ and R⁶ together with their directly attached carbons form a cycloaliphatic ring having a total of 5-6 carbon atoms or 4-5 carbon atoms and 1-2 oxygen atoms,

a=0-3, and

b=0 or 1.

If units (VII) are present, H can be a C2-8 alkylene, C5-6 cycloalkylene, or C6 arylene wherein the carboxy groups on the cycvlic compounds can be in the 1,2, 1,3, or 1,4 positions.

In yet another specific embodiment with reference to each of formulas (II), (III), (IV), (V), (VI), (VII), (VIII), and crosslinkable polyketal ester comprising units (I), where each equivalent of ketocarboxy (III) and polyol (V) or bisketal (VIII) is the same,

G is a C₂₋C₁₂ alkylene optionally substituted with up to 5 ether oxygens,

R² is C₁-C₂ alkyl,

R³ is hydrogen or C₁-C₃ alkyl,

R⁴ is hydrogen or C₁-C₃ alkyl,

R⁵ is hydrogen or C₁-C₃ alkyl,

R⁶ is hydrogen or C₁-C₃ alkyl,

a=1-2, and

b=0 or 1.

If units (VII) are present, H can be a C2-8 saturated alkylene or C6 arylene wherein the carboxy groups are in the 1,3, or 1,4 positions.

Even more specifically, the hydrocarbon polyol is an alkylene diol (IIa)

HO-G-OH (IIa)

wherein G is a C₂-C₃₂ alkylene, specifically a C₂-C₆ alkylene, specifically a C₂-C₄ alkylene. The diol 1,4-butanediol (BDO) can be specifically mentioned. The alkylene diol is esterified by reaction with 1.5 or more equivalents of a ketocarboxylic acid (levulinic acid) (IIIa)

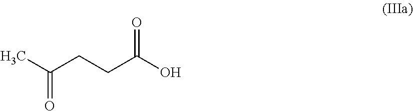

in the presence of an acid esterification catalyst, to produce a diketocarboxylic ester (IVa)

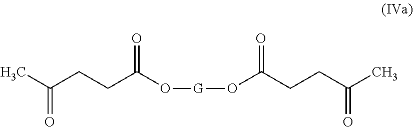

wherein G is a C₂-C₆ alkylene, specifically a C₂-C₄ alkylene, more specifically 1,4-butylene. Ketalizing the diketocarboxylic ester (IVa) with a polyol (Va),

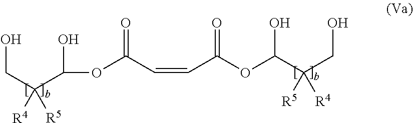

wherein R⁴ is hydrogen or C₁-C₃ alkyl, R⁵ is hydrogen or C₁-C₃ alkyl, a=2, and b=0 or 1 in the presence of a ketalization catalyst provides the crosslinkable polyketal ester comprising units (Ia)

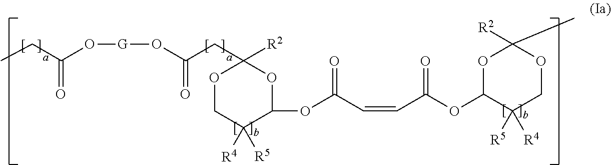

wherein

G is a C₂-C₃₂ alkylene, specifically a C₂-C₆ alkylene, specifically a C₂-C₄ alkylene,

R² is C₁₋₂ alkyl,

R⁴ is hydrogen or C₁-C₃ alkyl,

R⁵ is hydrogen or C₁-C₃ alkyl

a=2, and

b=0 or 1.

The crosslinkable polyketal ester can have from 1 to 500 units shown in (Ia), specifically 2-400, more specifically 2-300, 2-100, 2-50, 2-35, 2-20, 2-15, 2-10, or 2-5. Units of formula (VII) can optionally be present, where H is a C2-8 saturated alkylene or C6 arylene wherein the carboxy groups are in the 1,3 or 1,4 positions.

In another specific embodiment, the hydrocarbon polyol is an alkylene diol (IIb)

HO-G-OH (IIb)

wherein G is a C₂-C₆ alkylene, specifically a C₂-C₄ alkylene. The diol 1, 4-butanediol (BDO) can be specifically mentioned. The alkylene diol (IIb) is esterified by reaction with 1.5 or more equivalents of a ketocarboxylic acid (levulinic acid) (IIIb)

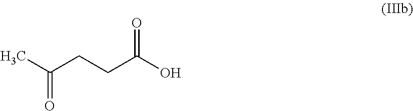

in the presence of an acid esterification catalyst, to produce a diketocarboxylic ester (IVb)

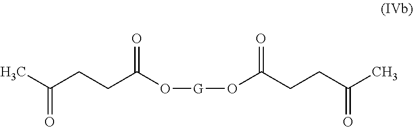

wherein G is a C₂-C₆ alkylene, specifically a C₂-C₄ alkylene, more specifically 1,4-butylene. Ketalizing the diketocarboxylic ester (IVb) with a 1,2-diol (Vb)

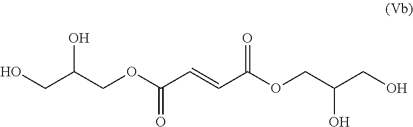 [SMILES: O=C(/C=C/C(=O)OCC(O)CO)OCC(O)CO]

and, optionally polyol (VI) wherein H a C2-8 saturated alkylene or C6 arylene wherein the carboxy groups are in the 1,3 or 1,4 positions, in the presence of a ketalization catalyst provides the crosslinkable polyketal ester (Ib)

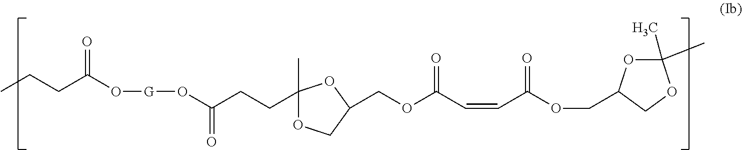

wherein G is a C₂-C₆ alkylene, specifically a C₂-C₄ alkylene, more specifically C₄. The crosslinkable polyketal ester can have from 1 to 500 units (Ib), specifically 2-400, more specifically 2-300, 2-100, 2-50, 2-35, 2-20, 2-15, 2-10, or 2-5, optionally together with units of formula (VI) wherein H is a C2-8 saturated alkylene or C6 arylene wherein the carboxy groups are in the 1,3 or 1,4 positions.

In an embodiment, in one method of manufacturing the crosslinkable polyketal ester comprising units (I), the hydrocarbon polyol (II) along with 1 or more, specifically 1.5-3, more specifically 2-2.5 equivalents of a ketocarboxy (III) and an acid catalyst are charged to a reactor.

The esterification and/or ketalization is conducted in the presence of an acid catalyst, which can be either a Lewis or Brønsted-Lowry acid. Acid catalysts that are known homogeneous catalysts for either ketal formation or esterification or transesterification reactions can be used, for example strong protic acid catalysts, e.g., Brønsted-Lowry acids that have a Ka of 55 or greater. Examples of strong protic acid catalysts include sulfuric acid, arylsulfonic acids, and hydrates thereof such as p-toluenesulfonic acid monohydrate, methane sulfonic acid, camphor sulfonic acid, dodecyl benzene sulfonic acid, perchloric acid, hydrobromic acid, hydrochloric acid, 2-naphthalene sulfonic acid, and 3-naphthalene sulfonic acid. In other embodiments, weak protic acid catalysts, e.g., having a Ka of less than 55, can be used, for example phosphoric acid, orthophosphoric acid, polyphosphoric acid, and sulfamic acid. Aprotic (Lewis acid) catalysts can include, for example, titanium tetraalkoxides, aluminum trialkoxides, tin(II) alkoxides, carboxylates, organo-tin alkoxides, organo-tin carboxylates, and boron trifluoride. A combination comprising any one or more of the foregoing acid catalysts can be used. In some embodiments, the method employs a substantially nonvolatile acid catalyst such that the acid does not transfer into the distillate, such as sulfuric or sulfamic acid. In an exemplary embodiment, the homogenous catalyst is camphor sulfonic acid.

Instead of, or in addition to the homogenous acid catalyst, a heterogenous acid catalyst can be used, where the acid catalyst is incorporated into, onto, or covalently bound to, a solid support material such as resin beads, membranes, porous carbon particles, zeolite materials, and other solid supports. Many commercially available resin-based acid catalysts are sold as ion exchange resins. One type of useful ion exchange resin is a sulfonated polystyrene/divinyl benzene resin, which supplies active sulfonic acid groups. Other commercial ion exchange resins include LEWATIT® ion exchange resins sold by the Lanxess Company of Pittsburgh, Pa.; DOWEX™ ion exchange resins sold by the Dow Company of Midland, Mich.; and AMBERLITE® and AMBERLYST® ion exchange resins sold by the Dow Company of Midland, Mich. In embodiments, AMBERLYST® 15, AMBERLYST® 35, AMBERLYST® 70 are used. In embodiments, NAFION® resins (from DuPont in Wilmington, Del.) may also be used as heterogeneous catalysts in neat form or filled with silica. In these embodiments, the resin-based catalyst is washed with water, and subsequently, an alcohol, such as methanol or ethanol, and then dried prior to use. Alternatively, the resin is not washed before its first use. In use, the heterogenous catalysts are added to a reaction mixture, thereby providing a nonvolatile source of acid protons for catalyzing the reactions. The heterogenous catalysts can be packed into columns and the reactions carried out therein. As the reagents elute through the column, the reaction is catalyzed and the eluted products are free of acid. In other embodiments, the heterogenous catalyst is slurried in a pot containing the reagents, the reaction is carried out, and the resulting reaction products filtered or distilled directly from the resin, leaving an acid-free material.

The amount of acid catalyst is about 2 to 20,000 parts per million (ppm), specifically about 10 to about 10,000 ppm, specifically about 20 to about 5000 ppm, and more specifically about 30 to about 2500 ppm, relative to the total weight of the reactants. In this case, the reactants are the sum of hydrocarbon polyol (II) and the 1.5 or more equivalents of a ketocarboxy(III).

When camphor sulfonic acid is used as the acid catalyst to produce the crosslinkable polyketal ester comprising units (I), it is used in amounts of about 5 to 5,000 parts per million (ppm), specifically about 10 to about 1000 ppm, specifically about 15 to about 800 ppm, and more specifically about 20 to about 600 ppm, relative to the total weight of the reactants. In this case, the reactants are the sum of hydrocarbon polyol (II) and the 1.5 or more equivalents of a ketocarboxy(III).

The acid catalyst can be charged directly into the reactant mixture comprising the hydrocarbon polyol (II) and the ketocarboxy (III) or alternatively it can be diluted in water or one of the reactants prior to being charged into the reactant mixture. The acid catalyst can be diluted to about 0.01N to about 5N, specifically about 0.1N to about 4N, and more specifically about 0.5N to about 3N prior to introduction into the reactant mixture. The dilute acid catalyst can be continuously added to the reactant mixture throughout the course of the reaction or alternatively it can be added instantaneously to the reactant mixture in a single charge.

In an embodiment, in one method of manufacturing the crosslinkable polyketal ester, the hydrocarbon polyol (II) and 1 or more equivalents of a ketocarboxy (III) are charged to the reactor. The reaction to produce the crosslinkable polyketal ester can be conducted in either a batch reactor, a continuous reactor or in a semicontinuous reactor. It is desirable for the reactor to have heating, cooling, agitation, condensation, and distillation facilities.

In an embodiment, the batch reactor for producing the crosslinkable polyketal esters can comprise a single continuous stirred tank reactor in fluid communication with a reboiler that is fitted with a distillation column. In another embodiment, the system (not shown) for producing the crosslinkable polyketal ester comprising units (I) can comprise a single continuous stirred tank reactor that is fitted with a distillation column. The distillation column is used to remove excess reactants and to distill the water condensate from the reaction.

In a batch reactor, the reactants and catalyst are charged to the reactor in batches and the product is extracted from the reactor in batches only after the reaction has been completed to an extent of about 80% or more. While a batch reactor can be used to react the reactants under a variety of different conditions, it is desirable to use a batch reactor when the product is manufactured by introducing the acid catalyst into the reactor in one charge. An exemplary batch reactor is a stainless steel or Hastelloy-type reactor. An example of a batch reactor is a continuous stirred tank reactor. It is desirable for the batch reactor to be equipped with distillation facilities for further purification of the product. The reaction to produce the crosslinkable polyketal ester comprising units (I) can be conducted in a single reactor or in plurality of batch reactors. In an embodiment, the esterification can be conducted in a batch reactor, while the ketalization can be conducted in the same or in a second batch reactor.

In a continuous reactor system the reactants are charged to a first reactor. When the conversion of reactants to products is measured to be greater than or equal to about 50%, a portion of the product mixture from the first reactor is subjected to additional finishing processes in a second reactor, while at the same time additional reactants and catalyst are continuously being charged to the first reactor to be converted into the crosslinkable polyketal ester comprising units (I). A continuous reactor system generally employs a plurality of reactors in series or in parallel so that various parts of the process can be conducted in different reactors simultaneously.

In an embodiment, the reactor comprises a plurality of reactors (e.g., a multistage reactor system) that are in fluid communication with one another in series or in parallel. The plurality of reactors are used to react the hydrocarbon polyol (II) with the ketocarboxy(III), to recycle the reactants and to remove unwanted byproducts and impurities so as to obtain a crosslinkable polyketal ester comprising units (I) that is stable and has a long shelf life. In an embodiment, a portion of the plurality of reactors can be used primarily to react reactants to manufacture the crosslinkable polyketal ester comprising units (I), while another portion of the plurality of reactors can be used primarily to isolate the polyketocarboxylic ester (IV) and yet another portion of the plurality of reactors can be used to produce the crosslinkable polyketal ester comprising units (I) or to remove the residual catalyst and other byproducts that can hamper the formation of a stable product that has good shelf stability.

In an exemplary embodiment, the esterification of the hydrocarbon polyol (II) with 1.5 or more equivalents of a ketocarboxy (III) to produce a polyketocarboxylic ester (IV) is conducted in a batch reactor. In one method of manufacturing the polyketocarboxylic ester (IV), a hydrocarbon polyol (II) and the ketocarboxy (III) are charged to the batch reactor along with the acid catalyst. The contents of the batch reactor are heated while being subjected to agitation. Volatile reactants or byproducts are collected in a condenser that is in fluid communication with the batch reactor. The polyketocarboxylic ester (IV) can be isolated from unreacted reactants and other reaction byproducts prior to the ketalizing. In an embodiment, the polyketocarboxylic ester (IV) is isolated via crystallization or distillation. In another embodiment, the polyketocarboxylic ester (IV) is recrystallized prior to ketalizing.

In an embodiment, the batch reactor is heated to a temperature of about 110 to about 260° C., specifically about 150 to about 250° C., and specifically about 160 to about 240° C. to facilitate the esterification of the hydrocarbon polyol (II) by the ketocarboxy (III). The esterification can be carried out under a blanket of an inert gas (e.g., argon, nitrogen, and the like) or alternatively can be carried out in a vacuum. The batch reactor can be subjected to a vacuum of about 5 to less than 760 torr, specifically about 10 to about 500 torr, more specifically about 10 to about 100 torr.

Upon completion of the esterification in the batch reactor, the reaction solution is cooled, which in some embodiments results in crystallization of the ketocarboxylic ester (IV), particularly where each of the hydroxyl groups as been esterified. The crystalline ketocarboxylic ester (IV) may be washed in a first solvent to remove any contaminants. The washed ketocarboxylic ester (IV) can then be redissolved in a second solvent and recrystallized to produce a pure form of the ketocarboxylic ester (IV). The first and the second solvent can be the same or different. In an embodiment, the first solvent is a protic solvent such as water, methanol, ethanol, or isopropanol, and the second solvent is water, methanol, ethanol, or isopropanol as well. In another embodiment, heating and cooling steps may be performed to conduct re-crystallization.

In still another embodiment upon completion of the esterification in the reactor, the ketocarboxylic ester (IV) is isolated from the reaction mixture by extraction and/or distillation. In either embodiment, the pure form of the ketocarboxylic ester (IV) can have a purity of greater than or equal to about 98%, specifically greater than or equal to about 99%, on a weight basis. The pure form of the ketocarboxylic ester (IV) wherein G is a C₂-C₆ alkylene, specifically a C₂-C₄ alkylene, more specifically 1,4-butylene comprises white, shiny, spherical flakes or needle-shaped crystals.

The polyketocarboxylic ester (IV) is then ketalized with the polyol (V) or the bisketal (VIII) to produce the crosslinkable polyketal ester comprising units (I). Thus, the polyketocarboxylic ester (IV), with or without purification as described above is then reacted with a stoichiometrically equivalent amount of the polyol (V) or the bisketal (VIII) in the presence of a second catalyst (or the same catalyst), in a ketalization reactor, which can be the same batch reactor or in a second batch reactor. The contents of the ketalization reactor are heated while being subjected to agitation to produce the crosslinkable polyketal ester comprising units (I), for example to a temperature of about 60 to about 200° C., specifically about 70 to about 160° C., and specifically about 80 to about 140° C. to produce the crosslinkable polyketal ester comprising units (I). The ketalization reactor can be subjected to a vacuum of 5 to about 500 torr, specifically about 10 to about 100 torr.

Following the passage of a suitable amount of time, the ketalization reactor is cooled and the reactants neutralized with a base. The products are isolated by filtration, and only optionally by distillation to obtain the crosslinkable polyketal ester comprising units (I). The crosslinkable polyketal ester comprising units (I) can be further purified, for example by extraction, neutralization, or distillation.

It is possible for the crosslinkable polyketal ester comprising units (I) to have a low yellowness index (YI), for example a YI of less than or equal to about 500, specifically less than or equal to about 300, and more specifically less than or equal to about 200, or less than or equal to about 200 as measured by ASTM E313. In a specific embodiment, the crosslinkable polyketal ester comprising units (I) can have a YI of less than or equal to about 100, specifically less than or equal to about 50 as measured by ASTM E313. In a particularly advantageous feature, such levels are obtainable without distillation of the crosslinkable polyketal ester comprising units (I) after synthesis.

In the alternative, or in addition, the crosslinkable polyketal ester comprising units (I) is obtained in a purity of greater than 50 wt %, specifically greater than 70 wt %, more specifically greater than 80 wt %, or greater than 90 wt %. As used herein “purity” refers to the total composition, which can contain additional products such as partially ketalized esters and/or the starting ketocarboxy compound (III). Purity can be determined via GC-MS, for example.

The crosslinkable polyketal ester comprising units (I) can be used as a polymer in a wide variety of applications. In one embodiment, the crosslinkable polyketal ester is crosslinked before or after shaping into an article.

Methods and reagents for crosslinking double bonds are known in the art. For example, crosslinking is generally conducted in the presence of a cure initiator (e.g., azobisisobutyronitrile (AIBN) or an organic peroxide) and a crosslinking agent. Exemplary organic peroxides include dibenzoyl peroxide, 2,3-dipentanedione peroxide, lauryl peroxide, and methyl ethyl ketone peroxide. The crosslinking agent can be any substance that promotes or regulates intermolecular covalent bonding between the polymer chains. The crosslinking agent can be a monomer or an oligomer that reacts with the ethylenic unsaturation of the ionic polymer. Exemplary crosslinking agents include ethylenically unsaturated aromatic compounds such as styrene, alpha-methyl styrene, para-methyl styrene, vinyl toluene, and the like; acrylamides such as octyl acrylamide; (meth)acrylates such as methyl(meth)acrylate, ethyl(meth)acrylate, butyl(meth)acrylate, and trimethylol propane triacrylate; cyanurates such as triallyl cyanurate and triallyl isocyanurate; allyl-substituted compounds such as diallyl maleate, diallyl tetrabromophthalate, diallyl phthalate and diallyl isophthalate; and other ethylenically unsaturated compounds. For example, an ethylenically substituted compound can be an exo-methylene carbocyclic lactone such as α-methylene lactones, for example of the formula (IX)

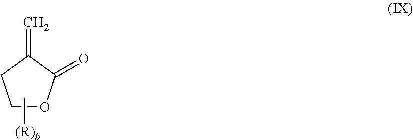

wherein b is 0, 1, 2, or 3, wherein each R is the same or different and is a substituted or unsubstituted C₁-C₁₂ hydrocarbylene, or two groups R are a substituted or unsubstituted C₂-C₆ group joined to form a ring that has 4 to 8 ring members, wherein the ring members can be carbon, sulfur, nitrogen, oxygen, or a combination thereof. For example, two R groups can be on adjacent carbon atoms and be joined to form substituted or unsubstituted C₃ group wherein all ring members are carbon, forming a 5-membered ring.

A specific α-methylene lactone is of the formula (IXa)

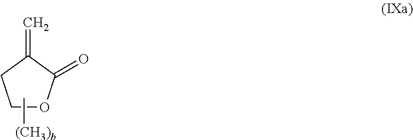

wherein b is 0 or 1, e.g., α-methylene-γ-valerolactone or, α-methylene-γ-butyrolactone.

The crosslinking agent can act as a solvent or diluent during crosslinking. Various promoters and accelerators can also be present, such as cobalt naphthenate or cobalt octoate, various tertiary amines such as dimethyl analine (DMA) and diethyl analine (DEA).

In another embodiment, the crosslinkable polyketal ester comprising units (I) can be used as an additive in a variety of organic polymers to form a polymer composition, before or after crosslinking. In an embodiment, the crosslinkable polyketal ester comprising units (I) or the crosslinked polyketal ester can be used as a plasticizer, a toughener, a surfactant, a barrier layer compound, an interfacial modifier, a compatibilizer, or a phase transfer compound, for example.

The organic polymer can be a thermoplastic or a thermosetting polymer. In an exemplary embodiment, the polymer is a thermoplastic. Examples of the organic polymer are cellulosics, polyacetals, polyacrylics, polyamideimides, polyamides, polyanhydrides, polyarylates, polyarylsulfones, polybenzoxazoles, polycarbonates, polyesters, polyetherketones, polyethersulfones, polyether ether ketones, polyether ketone ketones, polyetherimides, polyimides, polylactic acids, polyolefins, polyphenylene sulfides, polyphosphazenes, polyphthalides, polysilazanes, polysiloxanes, polystyrenes, polysulfides, polysulfonamides, polysulfonates, polysulfones, polysulfones, polytetrafluoroethylene, polythioesters, polyureas, polyvinyl acetates, polyvinyl alcohols, polyvinyl chlorides, polyvinyl esters, polyvinyl ethers, polyvinyl halides, polyvinyl ketones, polyvinyl nitriles, polyvinyl thioethers, polyvinylchlorides, or the like, or a combination comprising at least one of the foregoing organic polymers.

The crosslinkable polyketal ester can be added to the organic polymer in amounts of about 0.1 wt % to about 90 wt %, specifically about 4 wt % to about 70 wt %, and more specifically about 40 to 60 wt %, based on the total weight of the plasticized polymer.

In a method of manufacturing a polymer composition, the crosslinkable polyketal ester comprising units (I) is blended with an organic polymer. An exemplary form of blending involves melt blending, which comprises melting the thermoplastic polymer and dispersing the crosslinkable or crosslinked polyketal ester into the molten thermoplastic polymer. Pre-blending of the thermoplastic polymer and the crosslinkable polyketal ester comprising units (I) can be conducted prior to the melt blending.

In an embodiment, the compositions can be prepared by pre-blending the thermoplastic polymer and the crosslinkable or crosslinked polyketal ester prior to being fed into a melt blending device, although such pre-blending cannot always be desired. The pre-blending can be carried out in a mixer such as, for example, a drum mixer, ribbon mixer, vertical spiral mixer, Muller mixer, sigma mixer, chaotic mixer, static mixer, and the like. Pre-blending is generally carried out at room temperature.

In another embodiment, the crosslinkable polyketal ester comprising units (I) is blended with an organic thermosetting polymer, and initiator, an optional accelerator and a crosslinking agent. Examples of the organic thermosetting polymer include epoxy polymers, unsaturated polyester polymers, polyimide polymers, bismaleimide polymers, bismaleimide triazine polymers, cyanate ester polymers, vinyl polymers (e.g., styrenes), benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination comprising at least one of the foregoing thermosetting polymers.

The thermosetting polymers are melt blended with the crosslinkable polyketal ester, crosslinked polyketal ester, or a polymer composition comprising one of the foregoing, an initiator, a crosslinking agent, and an optional accelerator. The melt blending can result in the formation of an intermediate product such as, for example, pellets or briquettes that can be subsequently manufactured into an article or it can result in the direct formation of articles via a molding process.

Melt blending of the composition involves the use of shear force, extensional force, compressive force, ultrasonic energy, electromagnetic energy, thermal energy or combinations comprising at least one of the foregoing forces or forms of energy, and is conducted in processing equipment wherein the aforementioned forces or forms of energy are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing. Melt blending involving the aforementioned forces can be conducted in machines such as single or multiple screw extruders, Buss kneaders, Henschel mixers, helicones, Ross mixers, Banbury, roll mills, molding machines such as injection molding machines, vacuum forming machines, blow molding machines, or the like, or a combination comprising at least one of the foregoing machines. The melt blending is generally conducted at a temperature below the crosslinking temperature. Curing can be conducted after the melt blending is completed.

The crosslinkable polyketal ester, crosslinked polyketal ester, or polymer composition comprising one of the foregoing can be molded into an article having a desired shape. Molding can be conducted by compression molding, injection molding, vacuum forming, extrusion, blow molding, or the like.

In injection molding is generally conducted by injecting the crosslinkable polyketal ester, crosslinked polyketal ester, or a polymer composition comprising one of the foregoing into a heated mold. The crosslinking of the crosslinkable polyketal ester, or a polymer composition comprising one of the foregoing occurs in the mold. Following crosslinking, the mold is cooled and the finished product is removed. While injection molding is generally used with before the polymer is crosslinked, it can also be possible in some circumstance to mold the crosslinked polymer.

In one embodiment, the crosslinkable polyketal ester, crosslinked polyketal ester, or a polymer composition comprising one of the foregoing can be first blended with fibers and another thermosetting polymer and then placed in a mold and crosslinked to form an article. The fibers are generally non-conductive fillers and are listed below. This method of manufacturing crosslinked products may be used to manufacture products such as fiber glass.

The fibrous, non-conductive filler is selected from those that will impart improved properties to polymeric composites, and that have an aspect ratio greater than 1. As used herein, “fibrous” fillers may therefore exist in the form of whiskers, needles, rods, tubes, strands, elongated platelets, lamellar platelets, ellipsoids, micro fibers, nanofibers and nanotubes, elongated fullerenes, and the like. Where such fillers exist in aggregate form, an aggregate having an aspect ratio greater than 1 will also suffice for the purpose of this invention. Examples of such fillers well known in the art include those described in “Plastic Additives Handbook, 5th Edition” Hans Zweifel, Ed, Carl Hanser Verlag Publishers, Munich, 2001. Non limiting examples of suitable fibrous fillers include short inorganic fibers, including processed mineral fibers such as those derived from blends comprising at least one of aluminum silicates, aluminum oxides, magnesium oxides, and calcium sulfate hemihydrate, boron fibers, ceramic fibers such as silicon carbide, and fibers from mixed oxides of aluminum, boron and silicon sold under the trade name NEXTEL® by 3M Co., St. Paul, Minn., USA. Also included among fibrous fillers are single crystal fibers or “whiskers” including silicon carbide, alumina, boron carbide, iron, nickel, copper. Fibrous fillers such as glass fibers, basalt fibers, including textile glass fibers and quartz may also be included.

Also included are natural organic fibers known to those skilled in the art, including wood flour obtained by pulverizing wood, and fibrous products such as cellulose, cotton, sisal, jute, cloth, hemp cloth, felt, and natural cellulosic fabrics such as Kraft paper, cotton paper and glass fiber containing paper, starch, cork flour, lignin, ground nut shells, corn, rice grain husks and mixtures comprising at least one of the foregoing.

In addition, organic reinforcing fibrous fillers and synthetic reinforcing fibers may be used. This includes organic polymers capable of forming fibers such as polyethylene terephthalate, polybutylene terephthalate and other polyesters, polyarylates, polyethylene, polyvinylalcohol, polytetrafluoroethylene, acrylic resins, high tenacity fibers with high thermal stability including aromatic polyamides, polyaramid fibers such as those commercially available from Du Pont de Nemours under the trade name Kevlar, polybenzimidazole, polyimide fibers such as those available from Dow Chemical Co. under the trade names polyimide 2080 and PBZ fiber, polyphenylene sulfide, polyether ether ketone, polyimide, polybenzoxazole, aromatic polyimides or polyetherimides, and the like. Combinations of any of the foregoing fibers may also be used.

Such reinforcing fillers may be provided in the form of monofilament or multifilament fibers and can be used either alone or in combination with other types of fiber, through, for example, co-weaving or core/sheath, side-by-side, orange-type or matrix and fibril constructions, or by other methods known to one skilled in the art of fiber manufacture. Typical cowoven structures include glass fiber-carbon fiber, carbon fiber-aromatic polyimide (aramid) fiber, and aromatic polyimide fiber-glass fiber. Fibrous fillers may be supplied in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, performs and braids.

In general, the amount of fibrous filler present in the composition can be up to about 50 wt %, and preferably from about 0 to about 20 wt %, based on the total weight of the composition.

In a preferred embodiment, glass fibers are used as the non-conductive fibrous fillers to improve conductivity in these applications. Useful glass fibers can be formed from any type of fiberizable glass composition known to those skilled in the art, and include those prepared from fiberizable glass compositions commonly known as “E-glass,” “A-glass,” “C-glass,” “D-glass,” “R-glass,” “S-glass,” as well as E-glass derivatives that are fluorine-free and/or boron-free. Most reinforcement mats comprise glass fibers formed from E-glass and are included in the conductive compositions of this invention. Such compositions and methods of making glass filaments therefrom are well known to those skilled in the art.

Commercially produced glass fibers generally having nominal filament diameters of about 4.0 to about 35.0 micrometers, and most commonly produced E-glass fibers having nominal filament diameters of about 9.0 to about 30.0 micrometers may be included in the conductive compositions. The filaments are made by standard processes, e.g., by steam or air blowing, flame blowing, and mechanical pulling. The preferred filaments for plastics reinforcement are made by mechanical pulling. Use of non-round fiber cross section is also possible. The glass fibers may be sized or unsized. Sized glass fibers are conventionally coated on at least a portion of their surfaces with a sizing composition selected for compatibility with the polymeric matrix material. The sizing composition facilitates wet-out and wet-through of the matrix material upon the fiber strands and assists in attaining desired physical properties in the composite.

The glass fibers are preferably glass strands that have been sized. In preparing the glass fibers, a number of filaments can be formed simultaneously, sized with the coating agent, and then bundled into what is called a strand. Alternatively the strand itself may be first formed of filaments and then sized. The amount of sizing employed is generally that amount which is sufficient to bind the glass filaments into a continuous strand and ranges from about 0.1 to about 5 wt %, and more typically ranges from about 0.1 to 2 wt % based on the weight of the glass fibers. Generally, this may be about 1.0 wt % based on the weight of the glass filament. Glass fibers in the form of chopped strands about one-fourth inch long or less and preferably about one-eighth inch long may also be used. They may also be longer than about one-fourth inch in length if desired.

In general, the glass fibers are present in the composition in an amount of up to about 50 wt % based on the total weight of the composition, and preferably from about 0 to about 20 wt %, based on the total weight of the composition.

Following the incorporation of the fibrous, non-conductive fillers into the crosslinkable polyketal ester, crosslinked polyketal ester, or polymer composition comprising one of the foregoing, the composition can be poured or injected into a mold and cured to form a suitable product.

A variety of additives can be used with the crosslinkable polyketal ester, crosslinked polyketal ester, or polymer composition comprising one of the foregoing. These additives can include an antioxidant, an antiozonant, a thermal stabilizer, a mold release agent, a dye, a pigment, an antibacterial, a flavorant, a fragrance molecule, an aroma compound, an alkalizing agent, a pH buffer, a conditioning agent, a chelant, a solvent, a surfactant, an emulsifying agent, a foam booster, a hydrotrope, a solubilizing agent, a suspending agents, a humectant, an accelerator, a ultraviolet light absorber, an antifouling agent, a flame retardant additive, an odor scavenging agent, a blowing agent, a processing aid, an impact modifier, a toughener, an adjuvant, glass fibers, a cross-linking agent, or a combination comprising at least one of the foregoing additives.

The crosslinkable polyketal ester, crosslinked polyketal ester, or polymer composition comprising one of the foregoing are useful to form a variety of articles. An “article” as used herein is an item with a discrete shape, such as a tube, a film, a sheet, or a fiber, that incorporates one or more compositions of the disclosure; in some embodiments, the article can have its origin in a composition that undergoes a transformation, such as solidification or evaporation of one or more solvents, to result in the final article. In some embodiments, an article is substantially formed from a polymer composition of the invention; in other embodiments, the polymer composition of the invention forms only one part, such as one layer, of an article.

The article is, in some embodiments, a casing, a pipe, a cable, a wire sheathing, a fiber, a woven fabric, a nonwoven fabric, a film, a window profile, a floor covering, a wall base, an automotive item, a medical item, a toy, a packaging container, a screw closure or stopper adapted for a bottle, a gasket, a sealing compound, a film, a synthetic leather item, an adhesive tape backing, or an item of clothing. In some embodiments, the casing is a casing for an electrical device. In some embodiments, the medical item is medical tubing or a medical bag. In some embodiments, the film is a roofing film, a composite film, a film for laminated safety glass, or a packaging film. In some embodiments, the packaging container is a food or drink container. In some embodiments, the sealing compound is for sealed glazing. In some embodiments, the automotive item is seat upholstery, an instrument panel, an arm rest, a head support, a gear shift dust cover, a seat spline, a sound-deadening panel, a window seal, a landau top, a sealant, a truck tarpaulin, a door panel, a cover for a console and glove compartment, a trim laminating film, a floor mat, a wire insulation, a side body molding, an underbody coating, a grommet, or a gasket.

The crosslinkable polyketal ester or crosslinked polyketal ester can be used in a variety of health care products such as shampoos, lotions, shaving creams, deodorants, and the like.

In summary, in an embodiment, disclosed is a method for the manufacture of a crosslinkable polyketal ester comprising units (I)

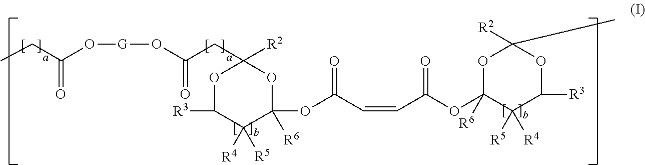

and optionally units (VII)

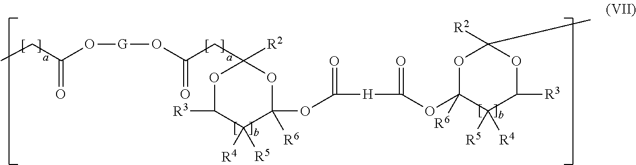

wherein H is a divalent linking group having more than 2 carbon atoms, G is a hydrocarbon group, R² is C₁-C₆ alkyl, R³ is hydrogen or C₁-C₆ alkyl, R⁴ and R⁵ are each independently hydrogen or C₁-C₆ alkyl, R⁶ is hydrogen or C₁-C₆ alkyl, or R³ and R⁶ together with their directly attached carbons form a fused cycloaliphatic or aromatic ring having a total of 5-6 carbon atoms or 4-5 carbon atoms and 1-2 oxygen atoms, a=0-3, and b=0 or 1, and optionally units (VII). The method comprising: (a) esterifying a hydrocarbon polyol (II)

HO-G-OH (II)

with at least 2 equivalents of a ketocarboxy(III) and an esterification catalyst,

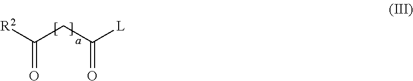

wherein each ketocarboxy (III) is the same or different, and wherein L is hydroxy, halide, or OR¹¹ wherein R¹¹ is a C₁-C₄ alkyl, to form a polyketocarboxylic ester (IV)

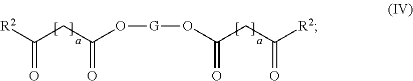

and
(b) ketalizing polyketocarboxylic ester (IV) with a molar excess of polyol (V) or bisketal (VIII) and optionally polyol (VI)

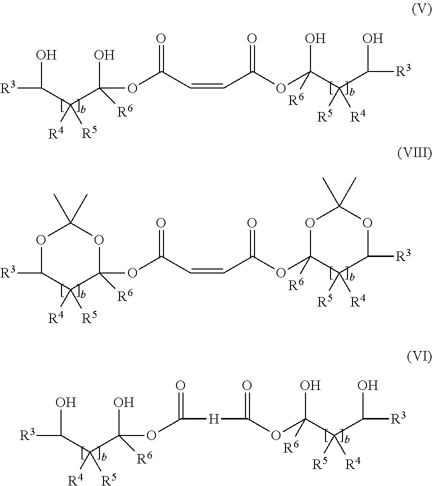

in the presence of a ketalization catalyst to provide the crosslinkable polyketal ester comprising units (I) and optionally units (VII).

In specific embodiments of the foregoing method, one or more of the following conditions can apply: the esterification is in the presence of a sulfuric acid, arylsulfonic acid, hydrate of an aryl sulfonic acid, p-toluenesulfonic acid monohydrate, methane sulfonic acid, camphor sulfonic acid, dodecyl benzene sulfonic acid, perchloric acid, hydrobromic acid, or hydrochloric acid esterification catalyst, or a combination comprising at least one of the foregoing catalysts, or a titanium tetraalkoxide, aluminum trialkoxide, tin(II) alkoxide, tin carboxylate, organo-tin alkoxide, organo-tin carboxylate, or a combination comprising at least one of the foregoing catalysts; the esterification catalyst is heterogenous; the esterifying of the hydrocarbon polyol (II) with the ketocarboxy (III) is conducted at a temperature of about 100 to about 260° C. and atmospheric pressure or a vacuum of about 10 to less than 760 torr; the polyketocarboxylic ester (IV) is not isolated prior to the ketalizing; the polyketocarboxylic ester (IV) is isolated prior to ketalizing; the isolating is by washing or crystallizing to produce an isolated, crystallized polyketocarboxylic ester (IV); the isolated, crystallized polyketocarboxylic ester (IV) is recrystallized prior to ketalizing; the ketalization catalyst is camphor sulfonic acid, dodecyl benzene sulfonic acid, or a combination thereof; the ketalization catalyst is a heterogeneous acid catalyst; the ketalization catalyst is the same as the esterification catalyst; the ketalizing of the polyketocarboxylic ester (IV) with the polyol (V) or the bisketal (VIII) is conducted at a temperature of about 60 to about 200° C. under a vacuum or under an inert gas purge; the method further comprises distilling excess reactant from the crosslinkable polyketal ester comprising units (I), or crystallizing excess ketocarboxylic ester (IV) from the ketalizaton reaction mixture; or the method further comprises removing the acid catalyst from the crosslinkable polyketal ester comprising units (I) comprising using a base, buffer, or anion exchange resin.

In another embodiment, disclosed is a method for crosslinking the crosslinkable polyketal ester comprising units (I)

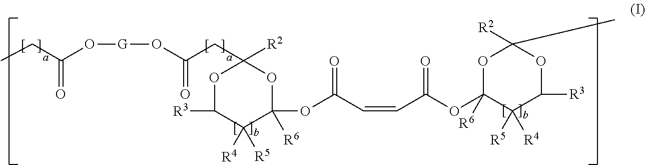

and optionally units (VII)

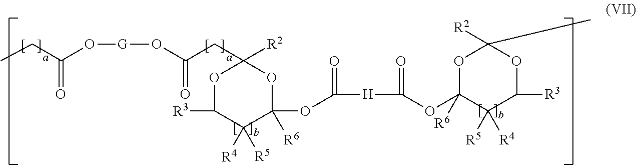

wherein H is a divalent linking group having more than 2 carbon atoms, G is a hydrocarbon group, R² is C₁-C₆ alkyl, R³ is hydrogen or C₁-C₆ alkyl, R⁴ and R⁵ are each independently hydrogen or C₁-C₆ alkyl, R⁶ is hydrogen or C₁-C₆ alkyl, or R³ and R⁶ together with their directly attached carbons form a fused cycloaliphatic or aromatic ring having a total of 5-6 carbon atoms or 4-5 carbon atoms and 1-2 oxygen atoms, a=0-3, and b=0 or 1. The method comprises crosslinking at least a portion of the polymer units (I) in the presence of an initiator and a crosslinking agent.

In specific embodiments of the foregoing method for crosslinking the crosslinkable polyketal ester, one or more of the following conditions can apply: the initiator is azobisisobutyronitrile, dibenzoyl peroxide, 2,3-dipentanedione peroxide, lauryl peroxide, methyl ethyl ketone peroxide, or a combination comprising at least one of the foregoing; or the crosslinking agent is styrene, alpha-methyl styrene, para-methyl styrene, vinyl toluene, an acrylamide, octyl acrylamide, methyl(meth)acrylate, ethyl(meth)acrylate, butyl(meth)acrylate, trimethylol propane triacrylate, triallyl cyanurate, triallyl isocyanurate, diallyl maleate, diallyl tetrabromophthalate, diallyl phthalate diallyl isophthalate, α-methylene-γ-valerolactone, α-methylene-γ-butyrolactone or a combination comprising at least one of the foregoing crosslinking agents.

In another embodiment, a composition comprises crosslinkable polyketal ester comprising units (I)

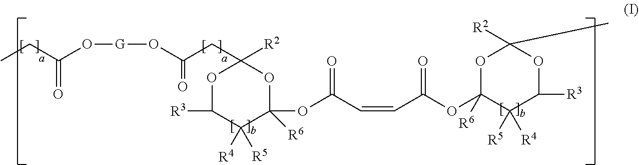

and optionally units (VII)

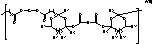

wherein H is a divalent linking group having more than 2 carbon atoms, G is a hydrocarbon group, each R² is independently C₁-C₆ alkyl, each R³ is independently hydrogen or C₁-C₆ alkyl, each R⁴ and R⁵ are each independently hydrogen or C₁-C₆ alkyl, each R⁶ is independently hydrogen or C₁-C₆ alkyl, or R³ and R⁶ together with their directly attached carbons form a cycloaliphatic or aromatic ring having a total of 5-6 carbon atoms or 4-5 carbon atoms and 1-2 oxygen atoms, each a independently is 0-3, and each b independently is 0 or 1.

In specific embodiments of the foregoing methods and compositions, one or more of the following conditions can apply: (i) each H is independently C2-32 alkylene, C4-8 cycloalkylene, C6-12 arylene, or C2-32-(R¹²O)_{q}R¹²— wherein each R¹² is methylene, ethylene, 1,3-propylene, or 1,2-propylene and q=1-31, G is a C₂-C₃₂ hydrocarbon containing 1 or more straight chain, branched or cyclic groups that can be saturated, unsaturated, aromatic, or substituted with up to 12 ether oxygens, each R² is independently C₁-C₃ alkyl, each R³ is independently hydrogen or C₁-C₃ alkyl, each R⁴ and R⁵ is independently each hydrogen or C₁-C₃ alkyl, each R⁶ is independently hydrogen or C₁-C₃ alkyl, or R³ and R⁶ together with their directly attached carbons form a fused cycloaliphatic or aromatic ring having a total of 5-6 carbon atoms or 4-5 carbon atoms and 1-2 oxygen atoms, each a independently is 0-3, and each b independently is 0 or 1; (ii) each H is the same C2-8 alkylene, C5-6 cycloalkylene, or C6 arylene wherein the carboxy groups on the cycvlic compounds can be in the 1,2, 1,3, or 1,4 positions, G is a C₂₋C₈ alkylene, C₂₋C₈ alkylene, C₅-C₈ cycloalkylene, or C₆-C₁₂ arylene, or C4-16-(R¹²O)_{q}R¹²— wherein each R¹² is independently ethylene, 1,3-propylene, or 1,2-propylene, and each q is 1-7, each R² is the same C₁-C₃ alkyl, each R³ is the same hydrogen or C₁-C₃ alkyl, each R⁴ is the same hydrogen or C₁-C₃ alkyl, each R⁵ is the same hydrogen or C₁-C₃ alkyl, each R⁶ is the same hydrogen or C₁-C₃ alkyl, or R³ and R⁶ together with their directly attached carbons form a fused cycloaliphatic or aromatic ring having a total of 5-6 carbon atoms or 4-5 carbon atoms and 1-2 oxygen atoms, each a=0-3, and each b=0 or 1; (iii) H is a C2-8 saturated alkylene or C6 arylene wherein the carboxy groups are in the 1,3 or 1,4 positions, G is a C₂₋C₁₂ alkylene optionally substituted with up to 5 ether oxygens, R² is C₁-C₂ alkyl, R³ is hydrogen or C₁-C₃ alkyl, R⁴ is hydrogen or C₁-C₃ alkyl, R⁵ is hydrogen or C₁-C₃ alkyl, R⁶ is hydrogen or C₁-C₃ alkyl, a=1-2, and b=0 or 1; (iv) the crosslinkable polyketal ester comprises units (Ia)

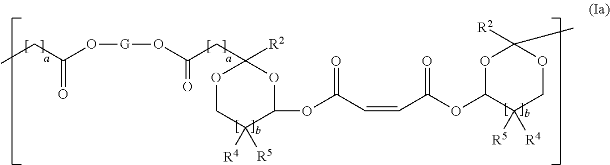

and optionally further comprises units (VII) wherein H is a C2-8 saturated alkylene or C6 arylene wherein the carboxy groups are in the 1,3 or 1,4 positions, and wherein G is a C₂₋C₆ alkylene, R² is C1-2 alkyl, R⁴ is hydrogen or C₁-C₃ alkyl, R⁵ is hydrogen or C₁-C₃ alkyl, a=2, and b=0 or 1; (v) the crosslinkable polyketal ester comprises units (Ib)

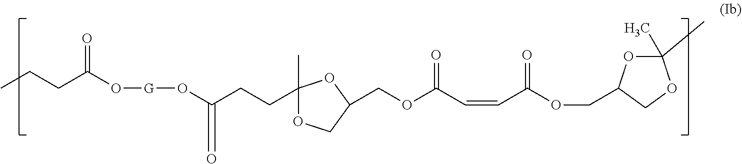

wherein G is a C₂-C₆ alkylene, and optionally further comprises units (VII) wherein H is a C2-8 saturated alkylene or C6 arylene wherein the carboxy groups are in the 1,3 or 1,4 positions; (vi) the crosslinkable polyketal ester has a purity of greater than 50 wt %.

In yet another embodiment, a composition comprises the crosslinked product of the foregoing crosslinkable polyketal esters. The crosslinked product is crosslinked using styrene, alpha-methyl styrene, para-methyl styrene, vinyl toluene, an acrylamide, octyl acrylamide, methyl(meth)acrylate, ethyl(meth)acrylate, butyl(meth)acrylate, trimethylol propane triacrylate, triallyl cyanurate, triallyl isocyanurate, diallyl maleate, diallyl tetrabromophthalate, diallyl phthalate, diallyl isophthalate, α-methylene-γ-valerolactone, α-methylene-γ-butyrolactone or a combination comprising at least one of the foregoing crosslinking agents.

In still another embodiment, a composition comprises an organic polymer; and the crosslinkable polyketal ester comprising units (I) or the crosslinked product thereof of any one of the foregoing embodiments.

In specific embodiments of the foregoing composition, one or more of the following can apply: the organic polymer is thermoplastic; the polymer is a polylactic acid, a polyvinylchloride, a polyacetal, a polyolefin, a polysiloxane, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, or a combination comprising at least one of the foregoing organic polymers; the organic polymer is a thermosetting polymer; the thermosetting polymer comprises epoxy polymers, unsaturated polyester polymers, polyimide polymers, bismaleimide polymers, bismaleimide triazine polymers, cyanate ester polymers, vinyl polymers, styrene polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or a combination comprising at least one of the foregoing thermosetting polymers; the composition further comprises an additive, where the additive is an antioxidant, an antiozonant, a thermal stabilizer, a mold release agent, a dye, a pigment, an antibacterial, a flavorant, a fragrance molecule, an aroma compound, an alkalizing agent, a pH buffer, a conditioning agent, a chelant, a solvent, a surfactant, an emulsifying agent, a foam booster, a hydrotrope, a solubilizing agent, a suspending agents, a humectant, an accelerator, a ultraviolet light absorber, or a combination comprising at least one of the foregoing additives; the composition further comprises glass fibers; or the glass fibers are E-glass, A-glass, C-glass, D-glass, R-glass, or S-glass fibers.

An article comprising the compositions or compositions made by the methods of any of any of the foregoing embodiments is also disclosed.

The following examples, which are meant to be exemplary, not limiting, illustrate compositions and methods of manufacturing of some of the various embodiments described herein.

### EXAMPLES

### Example 1

### Synthesis of Levulinic Acid-1,4-Butanediol-Levulinic Acid (LA-BDO-LA) with Sulfuric Acid Catalyst

This example was conducted to demonstrate a reaction between a hydrocarbon polyol (II) and a ketocarboxy (III) to isolate the polyketocarboxylic ester (IV). The reaction is shown in Scheme 1.

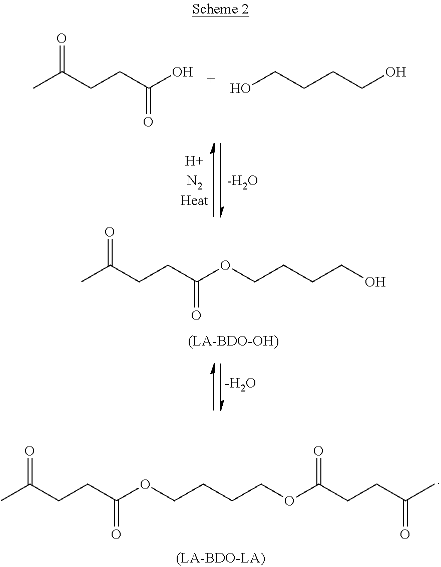

Levulinic acid (268.7 g, 2.3 mol), 1,4-butanediol (100.4 g, 1.1 mol), and sulfuric acid (99.8 μL, 500 ppm) were added to an empty 500 mL, 3-neck round bottom flask equipped with a magnetic stir-bar, Dean-Stark trap and overhead condenser, a thermocouple, and a nitrogen inlet. The contents were heated with a heating mantle for 2 hours from 140-180° C. The reaction began to produce volatile condensate at 140° C. As the reaction progressed over time, the temperature was increased incrementally in order to increase the rate of volatile condensate. The maximum temperature of the reaction was 180° C. Volatile condensate was collected in the Dean Stark trap.

A sample of the condensate was evaluated for the presence of tetrahydrofuran (THF). The condensate was measured to contain 20 wt % tetrahydrofuran, which correlates to greater than 10% yield loss (conversion) of 1,4-butanediol to tetrahydrofuran during the esterification reaction.

A sample of the reactor was analyzed by gas chromatography-flame ion detection (GC-FID) and the composition was found to be:

| | |
|---|---|
| 0.09% | un-reacted 1,4-butanediol, |
| 10.2% | un-reacted levulinic acid, |
| 1.3% | of hydroxy capped polyketocarboxylic ester (LA-BDO-OH), |
| 78% | of diketocarboxylic ester (LA-BDO-LA) product, and |
| 8.4% | unknown higher molecular weight species. |

Based on the un-reacted levulinic acid in the final composition, the formation of unknown higher molecular weight compounds, and the formation of a considerable amount of tetrahydrofuran, this process was found to be less selective toward the synthesis of LA-BDO-LA product.

### Example 2

### Synthesis of Diketocarboxylic Ester (LA-BDO-LA) with Camphor Sulfonic Acid Catalyst

As illustrated in Scheme 1, levulinic acid (268.3 g, 2.3 mol), 1,4-butanediol (99.3 g, 1.1 mol), and camphor sulfonic acid (75.1 mg, 200 ppm) were added to an empty 500 mL, 3-neck round bottom flask equipped with a magnetic stir-bar, Dean-Stark trap and overhead condenser, a thermocouple, and a nitrogen inlet. The contents were heated with a heating mantle for 6 hours at 140-180° C. The reaction began to produce volatile condensate at 140° C. As the reaction progressed over time, the temperature was increased incrementally in order to increase the rate of volatile condensate. The maximum temperature of the reaction was 180° C. Volatile condensate was collected in the Dean Stark trap.

A sample of the condensate was evaluated for the presence of tetrahydrofuran (THF). The condensate was measured to contain 1.8 wt % tetrahydrofuran, which correlates to less than 1% yield loss of 1,4-butanediol to tetrahydrofuran during the esterification reaction.

A sample of the reactor was analyzed by GC-FID and the composition was found to be as follows.

| | |
|---|---|
| 0.10%: | un-reacted 1,4-BDO |
| 10.6%: | un-reacted levulinic acid |
| 8.8%: | hydroxy capped polyketocarboxylic ester (LA-BDO-OH) |
| 78%: | diketocarboxylic ester (LA-BDO-LA) product |
| 1.7%: | unknown higher molecular weight species |

Based on the absence of a significant amount of unknown higher molecular weight compounds and the low yield loss of 1,4-butanediol to tetrahydrofuran, this process was found to be selective for the synthesis of LA-BDO-LA in high yields. This product crystallized after cooling. The crude brownish crystals were washed once with deionized water, and the product was filtered and dried into an off-white crystalline product. The yield of product was 200 grams. The composition by GC-FID was found to be as follows:

| | |
|---|---|
| 0.13%: | un-reacted 1,4-BDO |
| 0.65%: | un-reacted levulinic acid |
| 1.1%: | hydroxy capped polyketocarboxylic ester (LA-BDO-OH) |
| 97.8%: | diketocarboxylic ester (LA-BDO-LA) product |
| 0.2%: | unknown higher molecular weight species |

### Example 3

### Recrystallization of LA-BDO-LA

The LA-BDO-LA product from Example 2 was recrystallized in water to form white, shiny, spherical flakes and needle-shaped crystals. The crystalline sample was dried and analyzed using GC-FID. The crystalline sample had the following composition.

| non-detectable: | 1,4-BDO |
|---|---|
| 0.2%: | Un-reacted levulinic acid |
| 0.2% | LA-BDO-OH |
| 99.4% | LA-BDO-LA product |
| 0.1% | unknown higher molecular weight species |

Comparing examples 2 and 3, it can be seen that crystallizing the diketocarboxylic ester improves the purity of the diketocarboxylic ester to greater than 99%.

From the results obtained in examples, it can be seen that camphor sulfonic acid provides better yields of the diketocarboxylic ester especially when compared to sulfuric acid. The camphor sulfonic acid is therefore a more selective catalyst for manufacturing the diketocarboxylic ester.

In addition, it can be seen that washing of the diketocarboxylic ester crystals with water produces purer diketocarboxylic ester. The synthesis of the crosslinkable polyketal ester from the purer diketocarboxylic ester obtained from the Examples 2 and 3 also does not produce any undesirable high molecular weight species. In addition, the crosslinkable polyketal ester comprising units (I) has a yellowness index of less than or equal to about 200, specifically less than or equal to about 150, and more specifically less than or equal to about 100 as measured by ASTM E313.

### Example 4

### Synthesis of Di-Solketal Maleate

To a 3-neck, 500 mL round bottom flask equipped with magnetic stirring, nitrogen inlet, a temperature probe, electric heating mantle, a vigreux reflux column, and cooled distillate condenser was added solketal (280.1 g, 2.12 mol, Alfa Aesar lot 10151125) and dimethyl maleate (106.1 g, 0.736 mol, Aldrich lot MKBJ2834V). Nitrogen was passed through the vessel (0.1 SCFH) as it was heated to 170° C. for 30 minutes. The water concentration was measured to be 130 ppm. Titanium tetraisopropoxide (0.105 g) was added, and methanol was collected in the distillate receiver. The temperature was increased to 190° C. and the reaction was continued for 4 hours. The mixture was cooled to 25° C. The unreacted solketal was then removed from the reaction mixture by distillation initially at 5 torr vacuum, 95° C. pot temperature, and 75-76° C. vapor temperature. The vacuum was reduced to 1 torr to complete the distillation and 103.9 g of solketal was recovered. The liquid product (228.8 g) was then passed through a bed of silica gel (43 g, 60 Å, 60-200 μm) to yield 181.3 g of light yellow liquid product. The GC area % composition of the product is 0.73% solketal, 19.6% monosolketal monomethyl maleate, and 77.9% di-solketal maleate.

### Example 5A

### Synthesis of Unsaturated Polyester from LA-BDO-LA and Di-Solketal Maleate

An unsaturated polyester was made in accordance with Scheme 2.

To a round bottom flask was loaded LA-BDO-LA (11.44 g), di-solketal maleate (21.96 g) from example 4, and Amberlyst A-35 resin (1.03 g). The mixture was reacted at 80° C. under vacuum (20 torr) for 2 hours. The catalyst resin was removed by filtration through a 1.1 μm filter to yield a thick light yellow liquid. The molecular weight was measured by GPC to show the presence of the oligomers. The results are shown in Table 1.

TABLE 1

| Compound | GPC Area % |
|---|---|
| Monosolketal monomethyl maleate | 4.5 |
| LA-BDO-LA | 10.7 |
| di-solketal maleate | 20.9 |
| Higher molecular weight | 63.3 |

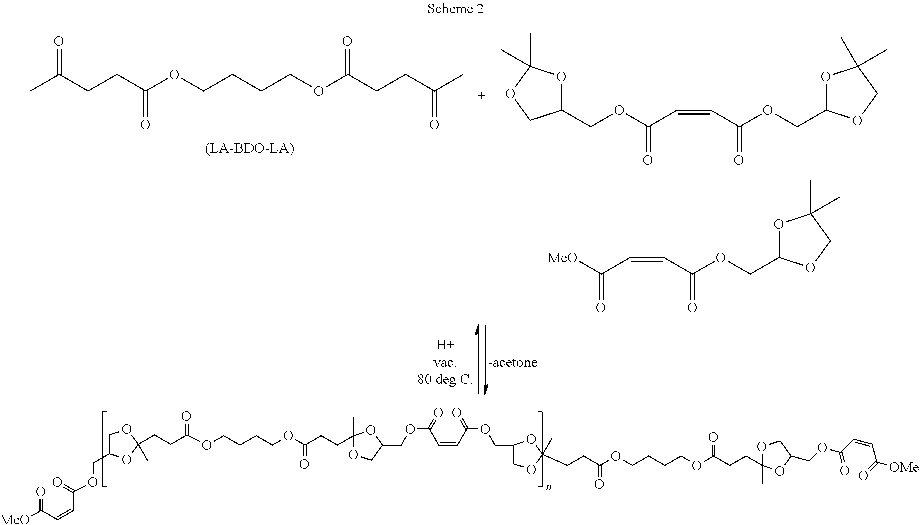

### Example 5B

### Synthesis of Unsaturated Polyester from LA-BDO-LA and Di-Solketal Maleate

To a round bottom flask was loaded LA-BDO-LA (11.44 g), di-solketal maleate (22.01 g), and Amberlyst A-35 resin (1.01 g). The mixture was reacted at 80° C. under vacuum (10 torr) for 6 hours. The catalyst resin was removed by filtration to yield a thick light yellow liquid. The molecular weight was measured by GPC to show the presence of oligomers. The results are shown in Table 2.

TABLE 2

| Compound | GPC Area % |
|---|---|
| Monosolketal monomethyl maleate | 4.2 |
| LA-BDO-LA | 6.2 |
| di-solketal maleate | 14.0 |
| Higher molecular weight | 74.6 |

### Example 6A

### Crosslinking of Polyketal Ester

To a vial was weighed polyester ketal from example 5A (5.01 g), AIBN (0.214 g), and styrene (5.8 g). The mixture was shaken until homogeneous, and then transferred into a 7 cm diameter aluminum tray and placed in a vacuum oven. The vacuum oven was inerted with 3 cycles of vacuum and backfilling with nitrogen. The oven was gradually heated to 70-75° C. while under positive nitrogen pressure and held for 14 hours. The solid product (7.78 g) was removed from the tray. The polymer product was observed to be a transparent, semi-rigid, flexible film. A sample of the product (2.94 g) was thoroughly extracted with 2-butanone in a soxhlet extractor (3 hours) and then dried until constant mass to yield 2.94 g of dried product. The mass recovery was 66% after extraction to indicate the polymer is a crosslinked thermoset.

### Example 6B

### Crosslinking of Polyketal Ester

To a vial was weighed polyester ketal from example 5B (5.27 g), AIBN (0.202 g), and styrene (5.19 g). The mixture was shaken until homogeneous, and then transferred into a 7 cm diameter aluminum tray and placed in a vacuum oven. The vacuum oven was inerted with 3 cycles of vacuum and backfilling with nitrogen. The oven was gradually heated to 70-75° C. while under positive nitrogen pressure and held for 14 hours. The oven was allowed to cool, and product (7.75 g) was removed from the tray. The polymer product was observed to be a transparent, semi-rigid, flexible film. A sample of the product (3.71 g) was thoroughly extracted with 2-butanone in a soxhlet extractor (3 hours) and then dried until constant mass to yield 2.59 g of dried product. The mass recovery was 70% after extraction to indicate the polymer is a crosslinked thermoset.

### Example 7

### Synthesis of Unsaturated Polyester from LA-BDO-LA and Di-Glyceryl Maleate (Prophetic)

A crosslinkable polyketal ester is made in accordance with Scheme 3.

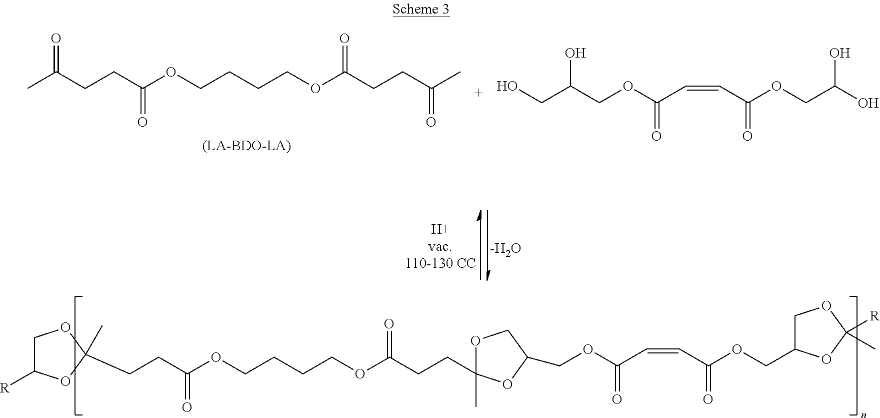

Accordingly, LA-BDO-LA (57.3 g, 0.2 mol), diglycerol maleate (52.9 g, 0.2 mol), and camphor sulfonic acid (200 ppm) are added to an empty 250 mL, 3-neck round bottom flask equipped with a magnetic stir-bar, Dean-Stark trap and overhead condenser, a thermocouple, and a glass stopper. The contents are heated with a heating mantle for 1 h at 110-130° C. under 10-30 Torr vacuum. Volatile condensate is collected in the Dean Stark trap. After 1 h, a sample is removed from the reactor and analyzed by GPC. The composition is found to be a polymer with a molecular weight of >1000 g/mol. The reaction is cooled and neutralized with solid dibasic sodium phosphate. The reaction mixture is filtered and stored for subsequent use. It is dark yellow, viscous polymer.

### Example 8

### Crosslinking of Polyketal Ester (Prophetic)

The polyketal ester is crosslinked as shown in Scheme 4, wherein “PS” is polystyrene.

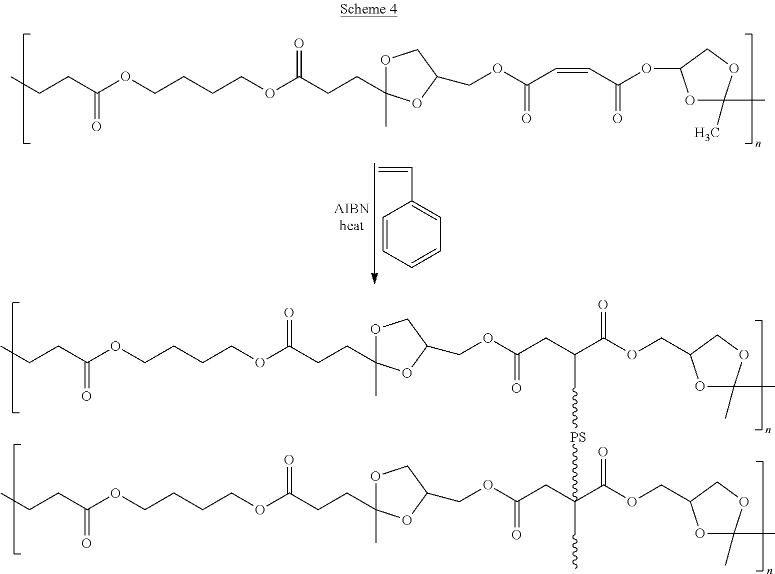

The polymer from Example 5 (50 grams), styrene (40 g), and 0.5 grams of AIBN is cast onto a glass dish and heated at 70° C. under vacuum for approximately 14 h. The polymer is allowed to cool. It is removed from the glass dish as a film. The polymer is a transparent, semi-rigid, flexible film that is insoluble in methylene chloride and THF, indicating that the polymer is a cross-linked thermoset.

### Example 6

### Synthesis of Unsaturated Polyester from LA-BDO-LA and Di-Glyceryl Maleate (Prophetic)

As shown in Scheme I, LA-BDO-LA (57.3 g, 0.2 mol), diglycerol maleate (52.9 g, 0.2 mol), and AMBERLYST® 70 resin (5000 ppm) are added to an empty 250 mL, 3-neck round bottom flask equipped with a magnetic stir-bar, Dean-Stark trap and overhead condenser, a thermocouple, and a glass stopper. The contents are heated with a heating mantle for 4 h at 110-130° C. under 10-30 Torr vacuum. Volatile condensate is collected in the Dean Stark trap. After 4 h, a sample was removed from the reactor and analyzed by GPC. The composition is found to be a polymer with a molecular weight of >2000 g/mol. The reaction is decanted from the heterogeneous resin and cooled. The product is a yellow viscous material.

As used herein, the singular forms “a,” “an,” and “the” are intended to include the plural forms as well, unless the context clearly indicates otherwise. The endpoints of all ranges directed to the same component or property are inclusive of the endpoint and independently combinable, except when the modifier “between” is used. The modifier “about” used in connection with a quantity is inclusive of the stated value and has the meaning dictated by the context (e.g., includes the degree of error associated with measurement of the particular quantity). A “combination” is inclusive of blends, mixtures, alloys, reaction products, and the like.

In general, the compositions or methods can alternatively comprise, consist of, or consist essentially of, any appropriate components or steps disclosed. The invention can additionally, or alternatively, be formulated so as to be devoid, or substantially free, of any components, materials, ingredients, adjuvants, or species, or steps used in the prior art compositions or that are otherwise not necessary to the achievement of the function and/or objectives of the present claims.

Unless otherwise defined, all terms (including technical and scientific terms) used have the same meaning as commonly understood by one of ordinary skill in the art to which this invention belongs. Compounds are described using standard nomenclature. Any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

“Alkyl” means a straight or branched chain saturated aliphatic hydrocarbon having the specified number of carbon atoms. “Alkylene” means a straight or branched divalent aliphatic hydrocarbon group having the specified number of carbon atoms and a valence of 2 or greater. “Aryl” means a cyclic moiety in which all ring members are carbon and a ring is aromatic. More than one ring can be present, and any additional rings can be independently aromatic, saturated or partially unsaturated, and can be fused, pendant, spirocyclic or a combination thereof. “(Meth)acrylate” encompasses both acrylate and methacrylate, and “(meth)acrylamide” encompasses both methacrylamide and acrylamide. While stereochemistry of the various compounds is not explicitly shown, it is to be understood that this disclosure encompasses all isomers.

All cited patents, patent applications, and other references are incorporated by reference in their entirety.

While the invention has been described with reference to exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for the manufacture of a crosslinkable polyketal ester comprising units (I) 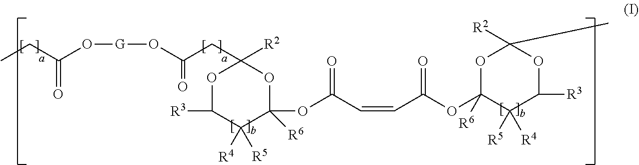
and optionally units (VII) 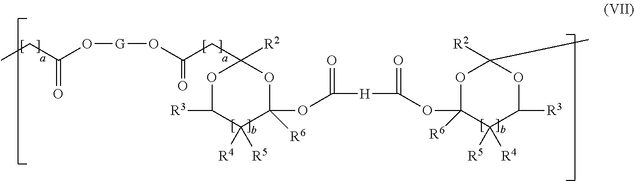
wherein
H is a divalent linking group having more than 2 carbon atoms,
G is a hydrocarbon group,
R² is C₁-C₆ alkyl,
R³ is hydrogen or C₁-C₆ alkyl,
R⁴ and R⁵ are each independently hydrogen or C₁-C₆ alkyl,
R⁶ is hydrogen or C₁-C₆ alkyl, or R³ and R⁶ together with their directly attached carbons form a fused cycloaliphatic or aromatic ring having a total of 5-6 carbon atoms or 4-5 carbon atoms and 1-2 oxygen atoms,
a=0-3, and
b=0 or 1, and optionally units (VII)
the method comprising:
(a) esterifying a hydrocarbon polyol (II)
HO-G-OH (II)
with at least 2 equivalents of a ketocarboxy(III) and an esterification catalyst, 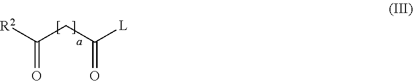
wherein each ketocarboxy (III) is the same or different, and wherein L is hydroxy, halide, or OR¹¹ wherein R¹¹ is a C₁-C₄ alkyl, to form a polyketocarboxylic ester (IV) 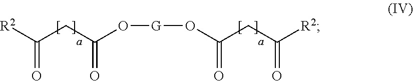
and
(b) ketalizing polyketocarboxylic ester (IV) with a molar excess of polyol (V) or bisketal (VIII) and optionally polyol (VI) 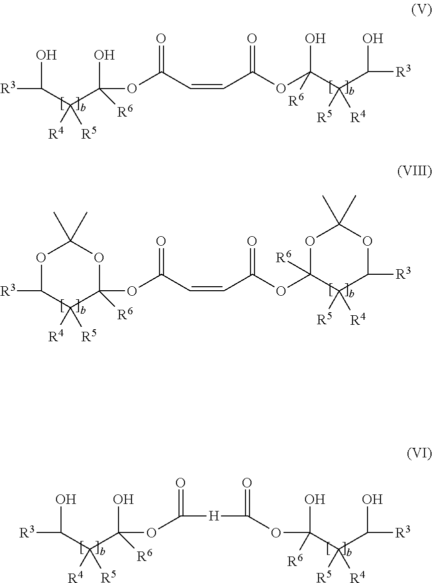
in the presence of a ketalization catalyst to provide the crosslinkable polyketal ester comprising units (I) and optionally units (VII).

2. The method of claim 1, wherein the esterification is in the presence of a sulfuric acid, arylsulfonic acid, hydrate of an aryl sulfonic acid, p-toluenesulfonic acid monohydrate, methane sulfonic acid, camphor sulfonic acid, dodecyl benzene sulfonic acid, perchloric acid, hydrobromic acid, or hydrochloric acid esterification catalyst, or a combination comprising at least one of the foregoing catalysts, or a titanium tetraalkoxide, aluminum trialkoxide, tin(II) alkoxide, tin carboxylate, organo-tin alkoxide, organo-tin carboxylate, or a combination comprising at least one of the foregoing catalysts.

3. (canceled)

4. The method of claim 1, wherein the esterifying of the hydrocarbon polyol (II) with the ketocarboxy (III) is conducted at a temperature of about 100 to about 260° C. and atmospheric pressure or a vacuum of about 10 to less than 760 torr.

5. (canceled)

6. (canceled)

7. The method of claim 1, wherein the polyketocarboxylic ester (IV) is isolated prior to ketalizing and the isolating is by washing or crystallizing to produce an isolated, crystallized polyketocarboxylic ester (IV).

8. (canceled)

9. The method of claim 1, wherein the ketalization catalyst is camphor sulfonic acid, dodecyl benzene sulfonic acid, or a combination thereof.

10. (canceled)

11. The method of claim 2, wherein the ketalization catalyst is the same as the esterification catalyst.

12. The method of claim 1, wherein the ketalizing of the polyketocarboxylic ester (IV) with the polyol (V) or the bisketal (VIII) is conducted at a temperature of about 60 to about 200° C. under a vacuum or under an inert gas purge.

13. (canceled)

14. (canceled)

15. A method for crosslinking the crosslinkable polyketal ester comprising units (I) 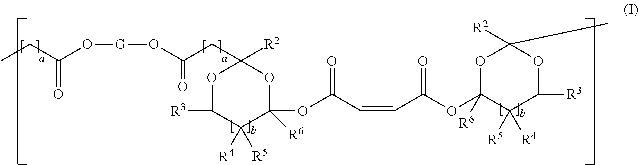
and optionally units (VII) 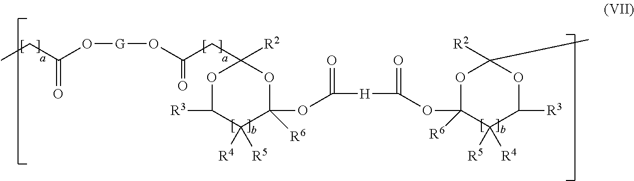
wherein
H is a divalent linking group having more than 2 carbon atoms,
G is a hydrocarbon group,
R² is C₁-C₆ alkyl,
R³ is hydrogen or C₁-C₆ alkyl,
R⁴ and R⁵ are each independently hydrogen or C₁-C₆ alkyl,
R⁶ is hydrogen or C₁-C₆ alkyl, or R³ and R⁶ together with their directly attached carbons form a fused cycloaliphatic or aromatic ring having a total of 5-6 carbon atoms or 4-5 carbon atoms and 1-2 oxygen atoms,
a=0-3, and
b=0 or 1,
the method comprising crosslinking at least a portion of the polymer units (I) in the presence of an initiator and a crosslinking agent.

16. The method of claim 15, wherein the initiator is azobisisobutyronitrile, dibenzoyl peroxide, 2,3-dipentanedione peroxide, lauryl peroxide, methyl ethyl ketone peroxide, or a combination comprising at least one of the foregoing.

17. The method of claim 15, wherein the crosslinking agent is styrene, alpha-methyl styrene, para-methyl styrene, vinyl toluene, an acrylamide, octyl acrylamide, methyl(meth)acrylate, ethyl(meth)acrylate, butyl(meth)acrylate, trimethylol propane triacrylate, triallyl cyanurate, triallyl isocyanurate, diallyl maleate, diallyl tetrabromophthalate, diallyl phthalate diallyl isophthalate, α-methylene-γ-valerolactone, α-methylene-γ-butyrolactone or a combination comprising at least one of the foregoing crosslinking agents.

18. A composition comprising crosslinkable polyketal ester comprising units (I) 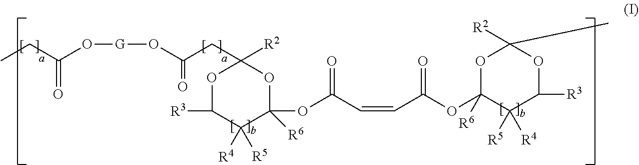
and optionally units (VII) 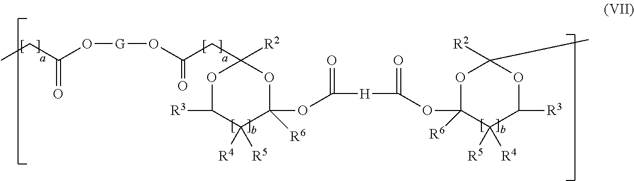
wherein
H is a divalent linking group having more than 2 carbon atoms,
G is a hydrocarbon group,
each R² is independently C₁-C₆ alkyl,
each R³ is independently hydrogen or C₁-C₆ alkyl,
each R⁴ and R⁵ are each independently hydrogen or C₁-C₆ alkyl,
each R⁶ is independently hydrogen or C₁-C₆ alkyl, or R³ and R⁶ together with their directly attached carbons form a cycloaliphatic or aromatic ring having a total of 5-6 carbon atoms or 4-5 carbon atoms and 1-2 oxygen atoms,
each a independently is 0-3, and
each b independently is 0 or 1.

19. The composition of claim 18, wherein
each H is independently C2-32 alkylene, C4-8 cycloalkylene, C6-12 arylene, or C2-32-(R¹²O)_{q}R¹²— wherein each R¹² is methylene, ethylene, 1,3-propylene, or 1,2-propylene and q=1-31,
G is a C₂-C₃₂ hydrocarbon containing 1 or more straight chain, branched or cyclic groups that can be saturated, unsaturated, aromatic, or substituted with up to 12 ether oxygens,
each R² is independently C₁-C₃ alkyl,
each R³ is independently hydrogen or C₁-C₃ alkyl,
each R⁴ and R⁵ is independently each hydrogen or C₁-C₃ alkyl,
each R⁶ is independently hydrogen or C₁-C₃ alkyl, or R³ and R⁶ together with their directly attached carbons form a fused cycloaliphatic or aromatic ring having a total of 5-6 carbon atoms or 4-5 carbon atoms and 1-2 oxygen atoms,
each a independently is 0-3, and
each b independently is 0 or 1.

20. (canceled)

21. (canceled)

22. The composition of claim 18, wherein the crosslinkable polyketal ester comprises units (Ia) 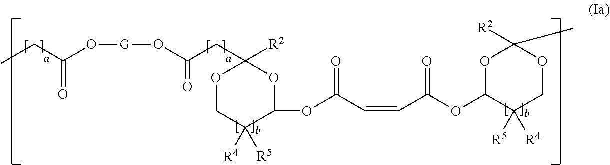
and optionally further comprises units (VII) wherein H is a C2-8 saturated alkylene or C6 arylene wherein the carboxy groups are in the 1,3 or 1,4 positions, and wherein
G is a C₂₋C₆ alkylene,
R² is C1-2 alkyl,
R⁴ is hydrogen or C₁-C₃ alkyl,
R⁵ is hydrogen or C₁-C₃ alkyl,
a=2, and
b=0 or 1

23. The compositions of claim 22, wherein the crosslinkable polyketal ester comprises units (Ib) 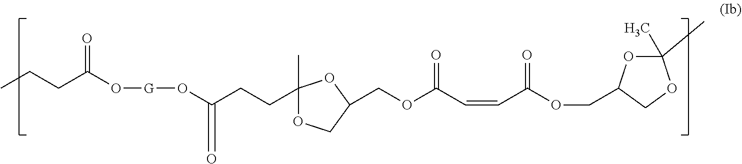
wherein G is a C₂-C₆ alkylene, and optionally further comprises units (VII) wherein H is a C2-8 saturated alkylene or C6 arylene wherein the carboxy groups are in the 1,3 or 1,4 positions.

24. (canceled)

25. A composition comprising the crosslinked product of the polyketal ester of claim 18.

26. The composition of claim 25, wherein the crosslinked product is crosslinked using styrene, alpha-methyl styrene, para-methyl styrene, vinyl toluene, an acrylamide, octyl acrylamide, methyl(meth)acrylate, ethyl(meth)acrylate, butyl(meth)acrylate, trimethylol propane triacrylate, triallyl cyanurate, triallyl isocyanurate, diallyl maleate, diallyl tetrabromophthalate, diallyl phthalate, diallyl isophthalate, α-methylene-γ-valerolactone, α-methylene-γ-butyrolactone or a combination comprising at least one of the foregoing crosslinking agents.

27. A composition comprising
an organic polymer; and
the crosslinkable polyketal ester comprising units (I) or the crosslinked product thereof of claim 18.

28. The composition of claim 27, wherein the organic polymer is a thermoplastic or a thermosetting polymer.

29. (canceled)

30. (canceled)

31. (canceled)

32. The composition of claim 27, further comprising an additive, where the additive is an antioxidant, an antiozonant, a thermal stabilizer, a mold release agent, a dye, a pigment, an antibacterial, a flavorant, a fragrance molecule, an aroma compound, an alkalizing agent, a pH buffer, a conditioning agent, a chelant, a solvent, a surfactant, an emulsifying agent, a foam booster, a hydrotrope, a solubilizing agent, a suspending agents, a humectant, an accelerator, a ultraviolet light absorber, or a combination comprising at least one of the foregoing additives.

33. The composition of claim 27, further comprising glass fibers.

34. (canceled)

35. An article comprising the composition of claim 18.
